(19) United States
(12) Patent Application Publication
(10) Pub. No.: US 2026/0329646 A1
(43) Pub. Date: Oct. 22, 2026

(54) DYNAMIC RESOURCE ALLOCATION FORECASTING

(71) Applicant: Oracle International Corporation, Redwood Shores, CA (US)

(72) Inventors: Srikanth Subrahmanya Nandula, Redwood City, CA (US); Kyasaram Vishwa Prasad, Telangana (IN); Raghavendra Kristam, Telangana (IN); Ram Mohan Yaratapally, Telangana (IN); Vaibhav Goyal, Telangana (IN)

(73) Assignee: Oracle International Corporation, Redwood Shores, CA (US)

(21) Appl. No.: 19/185,935

(22) Filed: Apr. 22, 2025

(51) Int. Cl. G06F 9/50

(52) U.S. Cl. CPC G06F 9/5027

(57) ABSTRACT

In some embodiments, a system, article, and computer-implemented method are disclosed for managing resource allocation. Trend markers are stored to indicate aggregate resource usage trends by one or more resource consumers which may be increasing or decreasing. A periodical determination of an aggregate resource usage by a resource consumer is made over two windows of time, one shorter and one longer period of time. The two windows of time are compared to determine an aggregate resource usage trend, which is compared to a previous aggregate resource usage trend. In the case that the current and previous aggregate resource usage trends are not consistent, a new resource trend marker is stored for the new aggregate resource usage trend. In the case that the trends are not consistent, an allocation of computing resources available to the one or more resource consumers is also changed based on the new aggregate resource usage trend.

### BACKGROUND

Computing systems handle workloads using available computing resources. Computing systems have limitations on the amount of resources available for various workloads in various contexts, and allocating too many resources to handle workload may result in excessive costs. Accommodating fluctuating workloads is technically complex in light of resource costs and limitations. Even as computing resources are re-configured to handle larger or smaller workloads, those workloads may change again to result in further mismatches between computing bandwidth and workload size.

Attempting to estimate future resource demand can lead to problems if done inaccurately. Using less resources than needed can cause a system to break or fail. Using more resources than needed is inefficient and can cause other workloads to be underserved by computing resources. Additionally, frequently calculating estimates and making adjustments may contribute additional analytical workload to an environment that is already resource constrained.

### BRIEF SUMMARY

In some embodiments, a system, article, and computer-implemented method are disclosed for managing resource allocation. Trend markers are stored to indicate aggregate resource usage trends by one or more resource consumers which may be increasing or decreasing. A periodical determination of an aggregate resource usage by a resource consumer is made over two windows of time, one shorter and one longer period of time. The two windows of time are compared to determine an aggregate resource usage trend, which is compared to a previous aggregate resource usage trend. In the case that the current and previous aggregate resource usage trends are not consistent, a new resource trend marker is stored for the new aggregate resource usage trend. In the case that the trends are not consistent, an allocation of computing resources available to the one or more resource consumers is also changed based on the new aggregate resource usage trend.

In a particular embodiment, a computer-implemented method includes storing a first trend marker in association with a particular time. The first trend marker indicates a first aggregate resource usage trend for aggregate resource usage by one or more resource consumers. The first aggregate resource usage trend may be increasing or decreasing at the particular time. The computer-implemented method also includes periodically determining a first aggregate resource usage by the one or more resource consumers over a first window of time relative to an end of a corresponding period and periodically determining a second aggregate resource usage by the one or more resource consumers over a second window of time relative to the end of the corresponding period. The first window of time is shorter than the second window of time. The computer-implemented method also includes, for a given period, comparing the first aggregate resource usage to the second aggregate resource usage to determine whether a second aggregate resource usage trend of the given period is consistent with the first aggregate resource usage trend. Based at least in part on determining that the second aggregate resource usage trend of the given period is not consistent with the first aggregate resource usage trend, a second trend marker is stored in association with an end of the given period that indicates the second aggregate resource usage trend for aggregate resource usage by the one or more resource consumers. Also based at least in part on determining that the second aggregate resource usage trend of the given period is not consistent with the first aggregate resource usage trend, an allocation of computing resources available to the one or more resource consumers is changed based on the second aggregate resource usage trend. The one or more resource consumers use computing resources according to the changed allocation.

In a further embodiment, the computer-implemented method also includes, waiting for an adjustment period after the changing the allocation of computing resources. After the adjustment period has passed and based at least in part on determining that the second trend marker is still a most recent trend marker, changing the allocation of computing resources available to the one or more resource consumers based on the second aggregate resource usage trend.

In the same or a different further embodiment, the computer-implemented method also includes receiving, via an interface, a change to an allocation change size and an adjustment period length. The changing the allocation of computing resources available to the one or more resource consumers changes the allocation by the allocation change size. The periodically changing the allocation of computing resources occurs at intervals based on the adjustment period length.

In another embodiment that extends the particular embodiment or any further embodiment, the computer-implemented method also includes, waiting for an adjustment period after the changing the allocation of computing resources. After the adjustment period has passed and based at least in part on determining that the second trend marker is not still a most recent trend marker, maintaining an allocation of computing resources available to the one or more resource consumers without change.

In another embodiment that extends the particular embodiment or any further embodiment, the changing the allocation of computing resources available to the one or more resource consumers based on the second aggregate resource usage trend results in a first allocation of computing resources. The computer-implemented method also includes, for another given period, comparing the first aggregate resource usage to the second aggregate resource usage to determine whether a third aggregate resource usage trend of the other given period is consistent with the second aggregate resource usage trend. The computer-implemented method also includes, based at least in part on determining that the third aggregate resource usage trend of the other given period is not consistent with the second aggregate resource usage trend storing, in association with an end of the other given period, a third trend marker that indicates the third aggregate resource usage trend for aggregate resource usage by the one or more resource consumers and changing an allocation of computing resources available to the one or more resource consumers based on the third aggregate resource usage trend to result in a second allocation of computing resources. The one or more resource consumers use computing resources according to the first allocation before changing the allocation of computing resources available to the one or more resource consumers based on the third aggregate resource usage trend. The one or more resource consumers use computing resources according to the second allocation after changing the allocation of computing resources available to the one or more resource consumers based on the third aggregate resource usage trend.

In another embodiment that extends the particular embodiment or any further embodiment, the changing the allocation of computing resources available to the one or more resource consumers is performed by a resource management node of a plurality of resource management nodes. Other resource management nodes of the plurality of resource management nodes manage allocation of resources for one or more other resource consumers of a plurality of resource consumers.

In another embodiment that extends the particular embodiment or any further embodiment, the computer-implemented method also includes monitoring unused allocated resources and separately allocating an amount of resources based at least in part on determining that a lower threshold of unused allocated resources is satisfied.

In another embodiment that extends the particular embodiment or any further embodiment, the computer-implemented method also includes monitoring unused allocated resources and separately de-allocating an amount of resources based at least in part on determining that an upper threshold of unused allocated resources is satisfied.

In another embodiment that extends the particular embodiment or any further embodiment, the determining that the second aggregate resource usage trend of the given period is not consistent with the first aggregate resource usage trend comprises determining that the second aggregate resource usage trend is positive or negative while the first aggregate resource usage trend is negative or positive, respectively.

In another embodiment that extends the particular embodiment or any further embodiment, the determining that the second aggregate resource usage trend of the given period is not consistent with the first aggregate resource usage trend comprises determining that the second aggregate resource usage trend exhibits a second rate of change that is in a different range than the first rate of change even though the first aggregate resource usage trend and the second aggregate resource usage trend are in the same direction.

In another embodiment that extends the particular embodiment or any further embodiment, the computer-implemented method also includes, for a period of decreased resource usage, increasing a step amount based on determining that an upper threshold of unused allocated resources is satisfied.

In another embodiment that extends the particular embodiment or any further embodiment, the computer-implemented method also includes, for a period of increased resource usage, increasing a step amount based on determining that a lower threshold of unused allocated resources is satisfied.

In some embodiments, a system is provided that includes one or more data processors and a non-transitory computer-readable storage medium containing instructions which, when executed on the one or more data processors, cause the one or more data processors to perform part or all of one or more methods disclosed herein.

In other embodiments, a computer-program product is provided that is tangibly embodied in a non-transitory and/or transitory machine-readable storage medium and that includes instructions configured to cause one or more data processors to perform part or all of one or more methods disclosed herein.

Cloud services, microservices, or other machine-hosted services may be offered that perform part or all of one or more methods disclosed herein. The machine-hosted services may be provided by a single machine, by a cluster of machines, or otherwise distributed across machines. The one or more machines may be configured to send and receive data, which may include instructions for performing the methods or results of performing the methods, via an application programming interface (API) or any other communication protocol.

In various embodiments, part or all of one or more methods disclosed herein may be performed by stored instructions such as a software application, computer program, or other software package installed in memory or other storage of a computing platform, such as an operating system, which provides access to physical or virtual computing resources. The operating system may provide access to physical or virtual resources of a mobile computing device, a laptop computing device, a desktop computing device, a server computing device, a container in a virtual machine on a computing device, or any other computing environment configured to execute stored instructions.

As used herein, the terms “first,” “second,” “third,” “fourth,” etc. are used as naming conventions to refer to separate items in a set of items or separate process instances of a set of process instances. These naming conventions do not imply ordering unless such ordering is explicitly noted using language specific to ordering, such as “before” or “after,” or unless such ordering is required to attain the expressly recited functionality, such as generating an item and later accessing the generated item.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1 illustrates a flow chart of an example process for managing resource allocation.

FIG. 2 illustrates a system diagram showing an example infrastructure for managing resource allocation.

FIG. 3 illustrates a diagram of an example user interface for monitoring resource demand and controlling management of resource allocation.

FIGS. 4A & B illustrate graph diagrams of an example resource demand and corresponding calculated moving averages.

FIG. 5 depicts a simplified diagram of a distributed system for implementing certain aspects.

FIG. 6 is a simplified block diagram of one or more components of a system environment by which services provided by one or more components of an embodiment system may be offered as cloud services, in accordance with certain aspects.

FIG. 7 illustrates an example computer system that may be used to implement certain aspects.

### DETAILED DESCRIPTION

A system, article, and computer-implemented method are disclosed for managing resource allocation by storing trend markers indicating a resource usage trend relative to two aggregate resource usages over two windows of time and periodically checking those two aggregate resource usages against the previous trend marker to determine if a reallocation of resources is required.

In various embodiments, the management of resource allocation is implemented using non-transitory and/or transitory computer-readable storage media to store instructions which, when executed by one or more processors of a computer system, cause display of the user interface and processing of the received input to manage resource allocation. The management of resource allocation may be implemented on a local or cloud-based computer system that includes processors and a display for showing the user interface to a user for management of resource allocation. The computer system may communicate with client computer systems for managing resource allocation.

A description of a system, method, and apparatus for management of resource allocation is provided in the following sections:
MONITORING RESOURCE DEMAND
DETECTING CHANGES TO RESOURCE DEMAND
ALLOCATION OF RESOURCES IN RESPONSE TO RESOURCE DEMAND TREND
REALLOCATION STEP AMOUNT AND TIME DELAY
COMPUTER SYSTEM ARCHITECTURE

The steps described in individual sections may be started or completed in any order that supplies the information used as the steps are carried out. The functionality in separate sections may be started or completed in any order that supplies the information used as the functionality is carried out. Any step or item of functionality may be performed by a personal computer system, a cloud computer system, a local computer system, a remote computer system, a single computer system, a distributed computer system, or any other computer system that provides the processing, storage and connectivity resources used to carry out the step or item of functionality.

### Monitoring Resource Demand

A resource may be any item or service available in a limited quantity or amount. In computer applications, RAM, VRAM, CPU processing, GPU processing, worker threads, application instances, database processes, storage space, bandwidth, network endpoints, AI agents, cloud computing availability, or other quantifiable aspects of a computer are referred to as computer resources. Resources may also describe aspects of organization management such as available stock for items such as inventory. As a resource is limited in quantity or amount, resources are managed by allocating available resources to various sources of demand for the resources. Sources of demand for a resource may be tasks, processes, users, consumers of a resource, or any other workload. For example, in the computer context, a source of demand for a CPU processing resource may be a queue of processing tasks. A resource is said to be consumed when used to fulfil a demand for the resource. Resources may represent aspects of a computer that are measured with respect to time, such as CPU processing. These resources may be said to be consumed when the resource is directed to perform an action to satisfy the resource demand for a period of time necessary to complete the action even though the resource may be made available after. In this case, the consumption of the resource refers to time elapsed while the resource is directed to satisfying the resource demand.

A resource may be controlled by a resource management system which monitors a resource demand for the resource and performs resource allocation of the resource in response to the resource demand. The resource management system may monitor a resource demand by accessing resource usage information from a connected resource usage service. The connected resource usage service may provide access to data regarding the current or historical resource usage of one or more resources used by the resource usage service. Resource usage data may be recorded by one or more sensors, agents, monitoring sub-services, or users of the resource usage service. The resource usage data may be recorded in a time series representing at least a current resource demand of the resource for each entry of the time series. The time series may be added to by the addition of a new entry to the time series according to a time series increment. The time series increment may be a division of time such as a second, minute, hour, or day, or a computer-based time division such as a number of processor ticks. At each newly added entry to the time series, the monitored resource demand may be calculated by accessing newly recorded resource usage data. At each newly added entry to the time series the resource management system may also perform calculations on the resource usage data to determine further information about the current resource demand.

A monitored resource demand is monitored for changes over time such that the system may account for the changed resource demand and supply an updated resource allocation to account for the current resource demand. Monitoring the resource demand and responding by allocating new resources only after the changed resource demand is detected by the monitoring causes the resource allocation to lag behind the resource demand which may cause issues such as slowing down processes relying on the allocation of resources or not meeting an immediate and time-sensitive need for the resources.

In order to meet the new resource demand at the time the resource demand is changed, the resource demand may be predicted by extrapolating information about the monitored resource demand. One important aspect of the monitored resource demand for predicting future resource demand changes is the trend of the resource demand. The trend may be a present tendency for the monitored resource demand to increase or decrease and the amount by which that increase or decrease will affect the monitored resource demand. A monitored resource demand trend may be estimated by first calculating a resource demand average. By calculating one or more resource demand averages at each entry in a time series, the current resource demand trend may be determined.

### Detecting Changes to Resource Demand

At each time increment, two resource demand aggregates may be calculated and compared, such as a slow moving average and a fast moving average. These moving averages are an average of the input value over a number of entries in the time series. The slow moving average is differentiated from the fast moving average by the window of time used in calculating the average. That is, the two averages differ in which entries of the time series are used for the average. The slow moving average uses a number of entries that span over at least one time series entry more than the time series entries used for the fast moving average. The slow moving average may therefore use a number of entries of the time series that are prior to any entry in the time series used for calculating the fast moving average. For example, the fast moving average may span four entries of the time series including the most recent entry in the time series to the fourth most recent entry in the time series and the slow moving average may span eight entries of the time series including the most recent entry in the time series to the eighth most recent entry in the time series.

In another example, the fast moving average may span five entries of the time series including the most recent entry in the time series to the fifth most recent entry in the time series and the slow moving average may span five entries in the time series including the sixth most recent entry in the time series and the tenth most recent entry in the time series.

Periodically as time progresses and more data is collected for further entries in the time series, the slow moving average and the fast moving average advance as they are recalculated for a new scope of time entries of the time series based on the most recent entry in the time series. At each entry in the time series, the slow moving average and the fast moving average may be calculated and compared. The slow moving average and the fast moving average may be compared to determine a relative position of the two averages such as which average is currently of a higher numerical value.

In comparing the slow moving average and the fast moving average, a change in the relative positions of the two averages indicates a change in the trend of the monitored resource demand. A change in the relative positions of the two averages may comprise a switching of the current higher value between the two averages. For example, a fast and slow moving average of current RAM demand may be a slow moving average RAM demand of 4 Gb and a fast moving average RAM of 3.8 Gb. In a next entry in the time series where real RAM demand has increased, the fast moving average may increase to 6 Gb whereas the slow moving average may only increase to 4.2 Gb. In this example, the fast moving average has moved relative to the slow moving average from a value below the slow moving average to a value above the slow moving average. This change in the relative positions between the two averages indicates a change in the trend of the RAM demand, such as an increase in the RAM demand.

Changes in the relative positions of the two averages may be recorded in association with entries where the change is detected. The change in the relative positions of the two averages may be recorded with a trend marker indicating a resource trend for resource usage by the resource usage service. The trend marker may be recorded with a direction of the trend such as a positive or negative trend. A positive change in the trend of the resource demand may be recorded when detecting the fast moving average to be above the slow moving average. A negative change in the trend of the resource demand may be recorded when detecting the slow moving average to be above the fast moving average.

Alternatively, a change in the relative positions of the two averages may be detected by determining that a distance between the relative positions of the two averages has changed. A change in the distance between the two averages may coincide with a change in the rate of change of the resource demand in the resource demand trend. In this case, a resource reallocation may be performed where the rate of change of the resource demand is of in a different range than the rate of change of a prior point in the time series even if the trend of the two points of the time series are in the same direction.

In comparing the relative positions of the two averages, a change in the relative positions may be determined by referring to a prior recorded trend marker to determine a direction of the trend for the prior entries in the time series and thus the relative positions of the two averages. If the current relative positions of the two averages indicate a different trend to the trend indicated by a prior trend marker, the new trend may be recorded with a new trend marker and a change to a resource allocation strategy may be performed. This process of analysis may be periodically repeated for each entry in the time series or at a regular interval to initiate a new resource allocation strategy each time a new trend is detected.

Table 1 depicts an example scenario recorded with a memory usage as the resource demand at each step of a time interval along with two calculated averages: a 4-time unit fast moving average and an 8-time unit slow moving average. The 4-time unit fast moving average calculates the average of the previous four recorded entries in the time series and the 8-time unit slow moving average calculates the average of the previous eight recorded entries in the time series.

TABLE 1

| | Memory | 4-Unit | 8-Unit |
|---|---|---|---|
| Time | Usage (MB) | Average | Average |
| 1 | 114.07 | | |
| 2 | 113.94 | | |
| 3 | 111.5 | | |
| 4 | 112.82 | | |
| 5 | 113.58 | 113.0825 | |
| 6 | 111.68 | 112.96 | |
| 7 | 111.68 | 112.395 | |
| 8 | 111.26 | 112.44 | |
| 9 | 110.62 | 112.05 | 112.56625 |
| 10 | 112 | 111.31 | 112.135 |
| 11 | 112 | 111.39 | 111.8925 |
| 12 | 111.49 | 111.47 | 111.955 |
| 13 | 106.76 | 111.5275 | 111.78875 |
| 14 | 110.54 | 110.5625 | 110.93625 |
| 15 | 113.02 | 110.1975 | 110.79375 |
| 16 | 114.25 | 110.4525 | 110.96125 |
| 17 | 114.32 | 111.1425 | 111.335 |
| 18 | 113.79 | 113.0325 | 111.7975 |
| 19 | 116.26 | 113.845 | 112.02125 |
| 20 | 117.06 | 114.655 | 112.55375 |
| 21 | 117.09 | 115.3575 | 113.25 |
| 22 | 115.8 | 116.05 | 114.54125 |
| 23 | 116.74 | 116.5525 | 115.19875 |
| 24 | 115.53 | 116.6725 | 115.66375 |
| 25 | 115.82 | 116.29 | 115.82375 |
| 26 | 112.91 | 115.9725 | 116.01125 |
| 27 | 113.81 | 115.25 | 115.90125 |
| 28 | 113.36 | 114.52 | 115.60 |

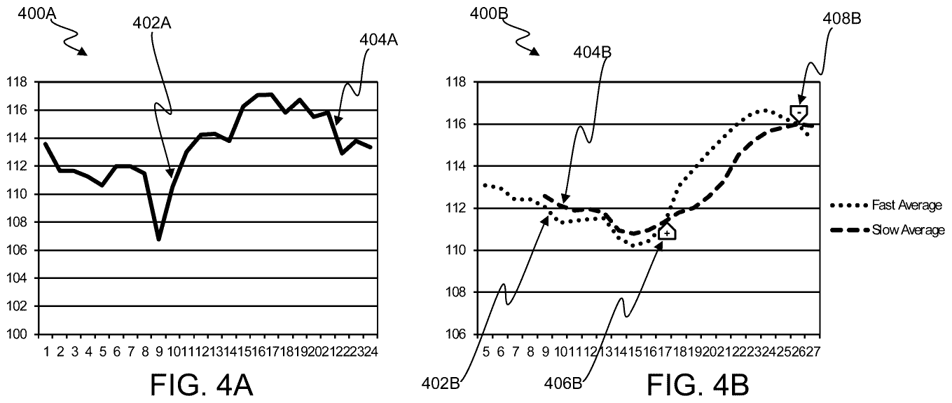

FIG. 4A depicts a selection of the data from Table 1 as a graph. A graph 400A depicts memory usage data against the time dimension as a line graph. The graph 400A includes a period of significantly increasing memory usage 402A indicated by a steep upward sloping line. The graph 400A also includes a period of significantly decreasing memory usage 404A indicated by a steep downward sloping line. FIG. 4B depicts a selection of the data from Table 1 as a graph. A graph 400B depicts the fast moving average 402B and slow moving average 404B data against the time dimension as line graphs. The graph includes a positive trend marker 406B at a point where the relative positions of the fast moving average 402B and the slow moving average 404B cross. The positive trend marker 406B corresponds to the period of significantly increasing memory usage 402A. This also corresponds to the record of Table 1 at time 18 where the fast moving average value (113.0325) raises above the slow moving average value (111.7975) compared to the previous values (111.1425 and 111.335). The graph also includes a negative trend marker 408B at a point where the relative positions of the fast moving average 402B and the slow moving average 404B switch back to their original relative positions. The negative trend marker 408B corresponds to the period of significantly decreasing memory usage 404A. This also corresponds to the record of Table 1 at time 26 where the fast moving average value (115.9725) drops below the slow moving average value (116.01125) compared to the previous values (116.29 and 115.82375).

### Allocation of Resources in Response to Resource Demand Trend

In response to detecting a change in the relative position of the two averages, a resource management system changes an allocation strategy of the resource. The resource management system may change an allocation strategy such as by changing from an increasing allocation strategy to a decreasing allocation strategy or from a decreasing allocation strategy to an increasing allocation strategy. The resource allocation strategy may be an ongoing pattern of allocation of the resource or an ongoing sequential increase or decrease to the allocated resource. The resource allocation strategy may increase or decrease the allocation of the resource according to the current trend of the resource demand.

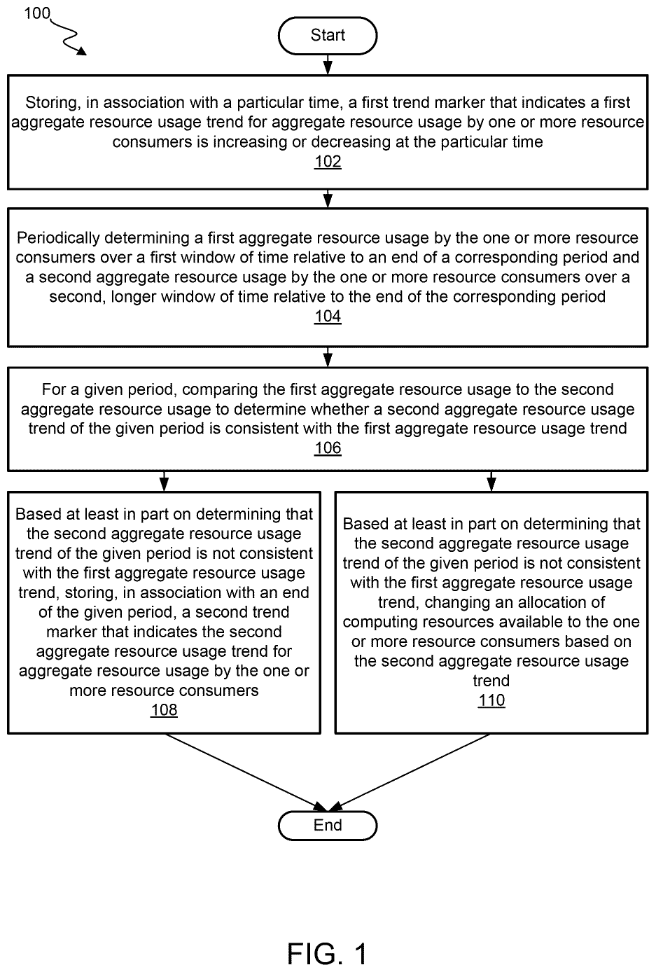

FIG. 1 depicts a flow chart process 100 for managing resource allocation. At block 102, a resource management system stores, in association with a particular time, a first trend marker. The first trend marker indicates a first aggregate resource usage trend for aggregate resource usage by one or more resource consumers is increasing or decreasing at the particular time. At block 104, the resource management system periodically determines a first aggregate resource usage by the one or more resource consumers over a first window of time relative to an end of a corresponding period. The resource management system also periodically determines a second aggregate resource usage by the one or more resource consumers over a second window of time relative to the end of the corresponding period. The first window of time is shorter than the second window of time. At block 106, for a given period, the resource management system compares the first aggregate resource usage to the second aggregate resource usage to determine whether a second aggregate resource usage trend of the given period is consistent with the first aggregate resource usage trend. At block 108, based at least in part on determining that the second aggregate resource usage trend of the given period is not consistent with the first aggregate resource usage trend, the resource management system stores, in association with an end of the given period, a second trend marker. The second trend marker indicates the second aggregate resource usage trend for aggregate resource usage by the one or more resource consumers. At block 110, also based at least in part on determining that the second aggregate resource usage trend of the given period is not consistent with the first aggregate usage trend, the resource management system changes an allocation of computing resources available to the one or more resource consumers based on the second aggregate resource usage trend. The one or more resource consumers use computing resources according to the changed allocation.

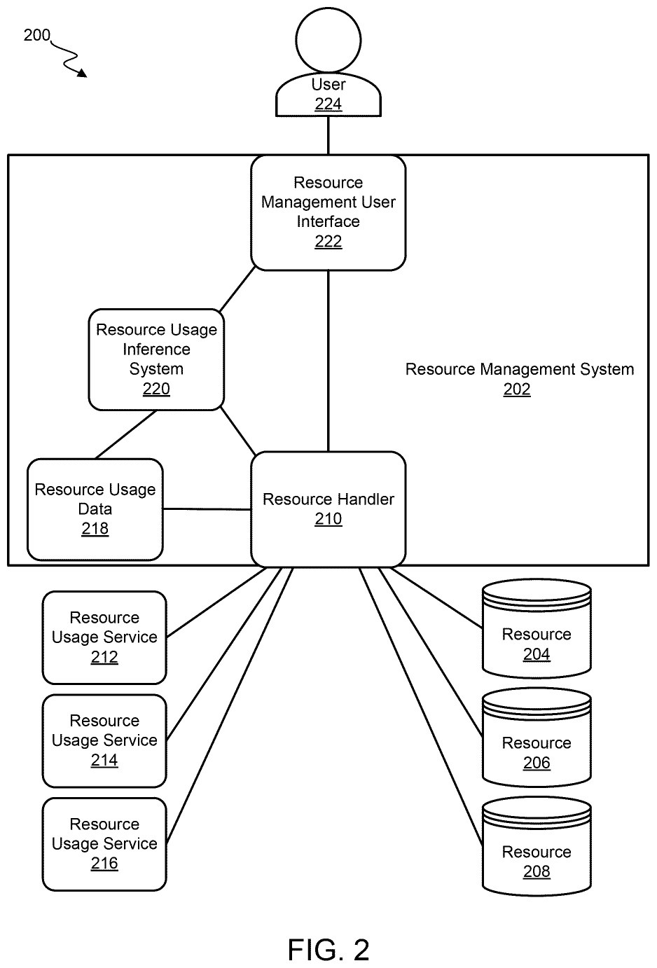

FIG. 2 depicts a system 200 for resource management. The system 200 includes a resource management system 202 that manages one or more resources 204-208. The resource management system 202 contains a resource handler 210 for directing the usage of the one or more resources 204-208. The resource handler 210 may direct the usage of the one or more resources 204-208 for one or more resource usage services 212-216. The resource handler 210 may be a distributed system of resource management nodes. The one or more resource usage services 212-216 report resource usage data 218 to the resource management system 202 which many store the resource usage data 218 to use with a resource usage inference system 220. The usage inference system 220 applies inference methods to the stored resource usage data 218 to infer trends in resource demand from the one or more resource usage services 212-216 for the one or more resources 204-208. The resource usage inference system 220 and the resource handler 210 may share data to a resource management user interface 222 which may be accessed by a user 224 to control settings within the resource management system 202 for controlling the management of the one or more managed resources 204-208.

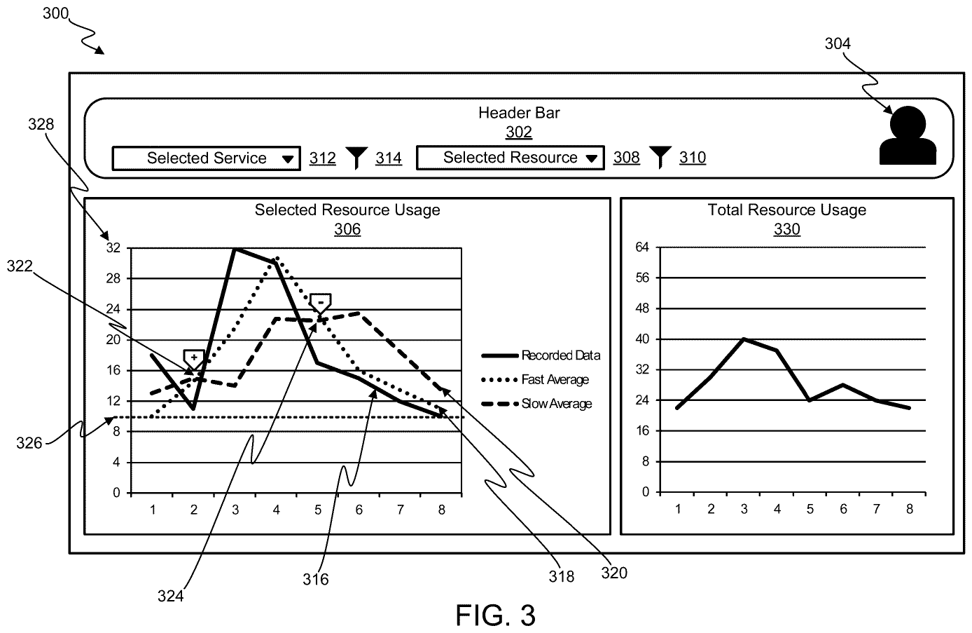

FIG. 3 depicts a user interface 300 for displaying resource management data. The user interface 300 may contain a controls region 302 for controlling the display of data within the user interface 300. The user interface 300 may recognize a user 304 such as by a set of user credentials which may be used to control what data is displayed in the user interface 300. The user interface includes a selected resource usage display region 306. The selected resource usage display region 306 displays data for a selected resource type 308. The resources to display as options for the selected resource type 308 may be controlled by a selected resource control 310 such as by filtering the possible resources. The selected resource usage display region 306 displays data for a selected resource usage service selected in a resource usage service selection option 312. The displayed resource usage services may be controlled by a resource usage selection control 314 such as to filter the options displayed. The selected resource usage display region 306 displays a graphical representation of recorded data 316 of resource demand for the selected resource type 308 by the selected resource usage service 312. The selected resource usage display region 306 also displays a first moving average 318 derived from values of the recorded data 316. The first moving average 318 is displayed along with a second moving average 320 derived from values of the recorded data 316. The first moving average 318 and the second moving average 320 may invert in relative positions. The point of inversion may be labeled as a positive inflection point 322 or a negative inflection point 324 depending on whether the change in relative positions indicates a trend in the recorded data 316 that is increasing or decreasing. The selected resource usage region 306 may also display a minimum allocated resources 326 and a maximum allocated resources 328 for the selected resource usage service 312. The user interface 300 may also contain a total resource usage display region 330 for displaying a graph of total resource usage for resources of the selected resource type 308.

After detecting a change in resource demand, a resource reallocation may be performed. Resource reallocation involves the direction of resources to or away from a resource usage service. Resources may be drawn from or returned to a common pool of unallocated resources or may be reallocated from use with one resource usage service to another resource usage service. Resource allocation may be controlled by a set of access controls to the resource such as by using address spaces or memory isolation in the case of computer memory, or by access keys in the case of accessing remote resources.

Resource reallocation may be performed by a node of a plurality of resource management nodes. For example, a change in the relative positions may be detected by an ongoing process to review incoming resource demand data and a resource management node may be tasked by the process with performing the resource reallocation. The resource management nodes may be nodes in a distributed system where management of multiple, separate resources may be performed in a pool as part of a shared, hierarchal management namespace for multiple, separate resource usage services or client devices. In this way, the resource management nodes may work as brokers for the various managed resources and can manage parked or unused resources and allocated resources or resources currently in use. A resource management node may be any type of node, agent, or process able to request or access resources on behalf of resource usage services.

In one example, the resource management node may be a ZooKeeper node within an Apache Kafka system. The ZooKeeper node may keep track of Kafka brokers, manage leader elections (e.g., to select a controller broker that oversees partition leadership tasks), and maintain cluster metadata (such as an active list of brokers), where each Kafka broker is a server instance that runs Kafka. In this example, at a given time, the Kafka brokers may be parked resources awaiting task assignment or resources that are in use to handle workload.

In a system using multiple resource management nodes, the resource management nodes risk causing conflicts with each other in management of the resources. In order to avoid this, the resource management nodes may maintain logs of the resources such as a parked resource log and an in-use resource log to track what resources are currently unused or currently allocated respectively. When allocating resources, a resource management node may check a log of parked resources and select one or more resources to allocate for a resource usage service. The resource management node may change the parked resource log to indicate that the selected one or more resources are no longer available. The resource management node may then provide access to the resources to the resource usage service and record the resources within the in-use resource log as currently allocated resources. When the resource demand of the resource usage service decreases, another resource management node may access the in-use resource log to select a number of resources currently allocated to the resource usage service that add up to the step size of resources to de-allocate from the resource usage service. The resource management node may then remove access to the selected resources from the resource usage service and remove the selected resources from the in-use resource log. The resource management node may then add the selected resources to the parked resource log, indicating that the resources are available to other resource usage services for other resource management nodes.

The resources available to be allocated, such as the resources listed in the parked resource log, may be managed by a second system for managing resources which allocates resources to pools of parked resources as a resource usage service. In this way, when a pool of available resources is low or depleted in servicing the resource usage services designated to access that pool of available resources, the second system for managing resource may allocate further resources to be allocated to the pool of available resources. The pool of available resources may act in this way as a resource usage service and may have its own upper and lower thresholds of allocated used or unused resources.

### Reallocation Step Amount and Time Delay

The resource allocation strategy may increase or decrease the allocation of the resources within a resource reallocation by a step amount. A step amount may be an amount of resource with which to change a current allocation of resources by. The step amount may be a pre-determined amount or may be calculated in response to further information about the current allocated resources or resource demand. A larger step amount may reduce the number of times a reallocation of resources is required leading to a greater benefit in the case that resource reallocation incurs a cost. A smaller step amount may increase the resolution by which allocation of resources is performed leading to a more accurate match to the resource demand.

The step amount may be determined as a setting set by a user. The user may access a user interface for managing resource allocation to change a setting for the step amount. Alternatively, the user may access the setting by request, such as by an API access, to change the setting for the step size. After a user has changed a step size, the resource management system may apply the step size for any further resource reallocation performed. The resource management system may also display to a user, such as via a user interface, a suggested step size if the resource management system detects a large number of instances of resource reallocations performed or if the resource management system detects that the current step size setting differs from a calculated optimal step size.

The step amount may be determined in part by determining current unused allocated resources for a resource usage service. A resource usage service may have a current resource allocation assigned to it. The resource usage service may not utilize all of the current resource allocation assigned to it at any given time and the current resource allocation for the resource usage service may be greater than the current resource demand of the resource usage service. At a given entry in the time series, the current unused allocated resources for a resource usage service is the part of the resources allocated to the resource usage service that is greater than the current resource demand of the resource usage service. The step amount for a change to a resource allocation strategy for a given resource usage service may account for the current unused allocated resources for the resource usage service or a total unused allocated resources for all resource usage services managed by the resource management system. For example, if the current unused allocated resources is high, then the step size for the resource allocation may be increased so as to reallocate more of the current unused allocated resources to other sources of resource demand. In another example, the current unused allocated resources may be compared to a threshold for unused allocated resources. If the current unused allocated resources is above the threshold for unused allocated resources, the step size may be increased, for a period of decreasing resource demand, to de-allocate an amount of resources from the resource usage service. The threshold may also cause the step size to decrease for periods of increasing resource demand when the current unused allocated resources is above the threshold. In yet another example, a lower threshold for unused allocated resources may be used. The current unused allocated resources may be compared to the lower threshold for unused allocated resources and the step size may be decreased, for a period of decreasing resource demand, in response to the current unused allocated resources being lower than the lower threshold for unused allocated resources. The lower threshold may also be used to cause the step size to increase for a period of increasing resource demand when the current unused allocated resources is below the lower threshold.

The step amount may also be determined in part by determining a current allocated resources for a resource usage service. The resource management system may store a maximum allocated resources for a resource usage service. When determining a step amount for a resource usage service, the resource management system may check the current allocated resources against the maximum allocated resources for the resource usage service in question. The step amount may be determined based on the proximity of the current allocated resources to the maximum allocated resources. In one example, the current allocated resources may be equal to the maximum allocated resources at the time of detecting an increase in demand from the resource usage service for the resource. In response, the step amount may be set to be zero, such that the resource allocation for the resource usage service does not exceed the maximum allocated resources. In another example, the current allocated resources may be determined to be close to the maximum allocated resources at the time of detecting an increase in demand from the resource usage service for the resource. In response, the step amount may be set to a smaller amount than otherwise indicated. In yet another example, the current allocated resource may be determined to be close to the maximum allocated resources at the time of detecting a decrease in demand from the resource usage service for the resource. In response, the step amount may be set to a larger amount than otherwise indicated.

The step amount may also be determined in part by determining a current total allocated resources. When determining a step amount for a resource usage service, the resource management system may check the current total allocated resources against a total available resources. In one example, the ability to allocate resources to further resource usage services may be preserved by changing a step size to be smaller or larger than otherwise indicated when a current total allocated resources is close to the total available resources when a resource demand is increasing or decreasing respectively. In another example, the step size may be changed to be equal to zero in response to detecting that the current total allocated resources is equal to or within a threshold distance to the total available resources.

The step amount may be determined in part by determining the distance between the relative positions between the fast moving average and the slow moving average. The distance between the relative positions of the two averages may be used as a measure of the extent of a change in the trend of the resource demand. The distance between the relative positions of the two averages has a direct relationship to the rate of change of the two averages over time. For example, the step amount may be determined to be larger when the distance between the relative positions of the two averages is large.

In implementing a resource reallocation, the reallocation may be performed after a time delay or adjustment period after an entry in the time series where a change in the relative positions of the slow moving average and fast moving average is detected. A time delay may be a number of entries in the time series between a detection of a change in the relative positions of the two averages and the point of implementing a resource reallocation. When a change in the relative positions of the two averages is detected, the change may be recorded, such as with a trend market, and a setting for a time delay may be checked. If a time delay is set, the resource management system may wait for the number of entries in the time series of the time delay. At the end of the time delay, the relative positions of the two averages may be checked again to determine if the relative positions have changed again. This check may also be performed by checking the list of trend markers to determine if the prior trend marker is still the most recent trend marker, indicating that no further change in the relative positions of the two averages has been detected. If the change originally detected still describes the relative positions of the two averages, a resource reallocation may be performed. If instead the change originally detected no longer describes the relative positions of the two averages, such as in the case where the change has inverted, the resource reallocation may not be applied and the current resource allocation strategy is be maintained. In this way, a time delay may be set in order to reduce instances of reallocating resources due to brief variations or noise in the resource demand. The amount of time set for the time delay may determine the sensitivity to noise of the resource reallocation with a longer time delay being less sensitive to changes in the resource demand.

The time delay may be set by a user as a setting for managing resource allocation. A user may interact with a user interface to determine a time delay setting to store for use in managing resource allocation. Alternatively, the user may access a resource management service by request, such as by an API access, to submit a change to a time delay setting. Further checks on the two averages may be performed by using the new time delay setting as set after a user has entered a new time delay setting.

The resource management system may prompt a user to submit feedback for the current resource allocation strategy based on the time delay and step size settings. The user may submit feedback which is accessed by the system to determine if an alteration to the time delay or step size settings should be made. The feedback may be related to the number of resource reallocations in alternating directions, in which case the time delay may be altered to either increase to reduce the number of reallocations or decrease to increase the number of reallocations. The feedback may instead be related to the number of reallocations in the same direction, in which case the step size may be altered to either increase to reduce the number of reallocations in the same direction or decrease to increase the number of reallocations in the same direction. The feedback may also indicate a sensitivity of one or more resource usage services to inaccurate allocations of resources that is not currently satisfied, such as instances of a resource usage service being allocated insufficient resources. In response the step size or time delay may be altered to make the resource management system more or less sensitive to changes in the resource demand and/or more or less reactive to detected changes in the resource demand.

Feedback may also be derived from internally recorded metadata indicating performance of the resource management system. The resource management system may record, along with the reported resource demand from various resource usage services, the calculated averages for the resource demand and the history of allocated resources. The recording of resource allocation history may be performed by resource management nodes when performing reallocations of resources. The stored metadata may be analyzed to determine a disparity between the history of allocated resources and the history of recorded resource demand. In response, the resource management system may generate internal feedback indicating that the step size or time delay should be adjusted to reduce the calculated disparity in allocated resources and recorded resource demand.

### Computer System Architecture

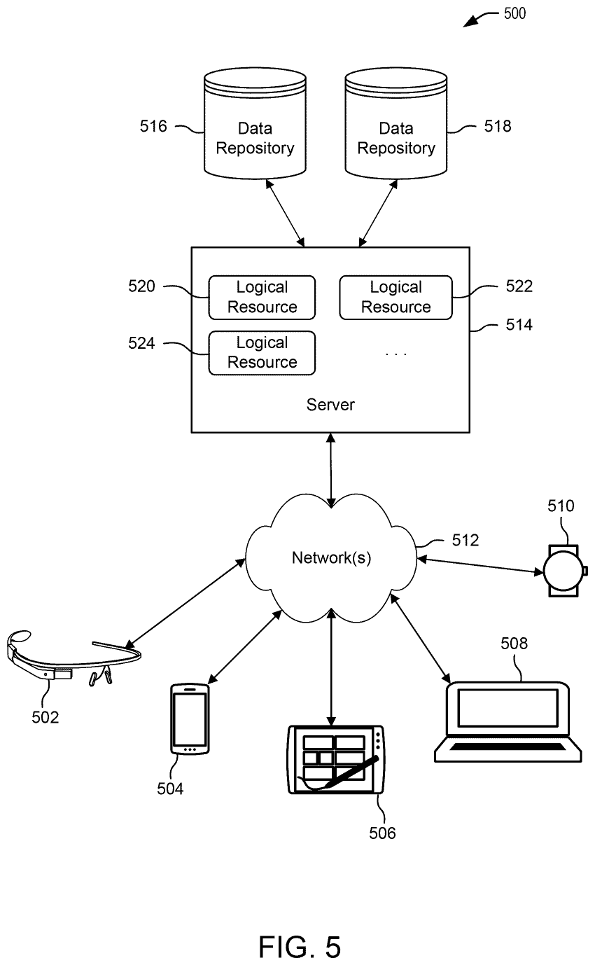

FIG. 5 depicts a simplified diagram of a distributed system 500 for implementing an embodiment. In the illustrated embodiment, distributed system 500 includes one or more client computing devices 502, 504, 506, 508, and/or 510 coupled to a server 514 via one or more communication networks 512. Clients computing devices 502, 504, 506, 508, and/or 510 may be configured to execute one or more applications.

In various aspects, server 514 may be adapted to run one or more services or software applications that enable techniques for managing resource allocation.

In certain aspects, server 514 may also provide other services or software applications that can include non-virtual and virtual environments. In some aspects, these services may be offered as web-based or cloud services, such as under a Software as a Service (SaaS) model to the users of client computing devices 502, 504, 506, 508, and/or 510. Users operating client computing devices 502, 504, 506, 508, and/or 510 may in turn utilize one or more client applications to interact with server 514 to utilize the services provided by these components.

In the configuration depicted in FIG. 5, server 514 may include one or more components 520, 522 and 524 that implement the functions performed by server 514. These components may include software components that may be executed by one or more processors, hardware components, or combinations thereof. It should be appreciated that various different system configurations are possible, which may be different from distributed system 500. The embodiment shown in FIG. 5 is thus one example of a distributed system for implementing an embodiment system and is not intended to be limiting.

Users may use client computing devices 502, 504, 506, 508, and/or 510 for techniques for managing resource allocation in accordance with the teachings of this disclosure. A client device may provide an interface that enables a user of the client device to interact with the client device. The client device may also output information to the user via this interface. Although FIG. 5 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux® or Linux-like operating systems such as Oracle® Linux and Google Chrome® OS) including various mobile operating systems (e.g., Microsoft Windows Mobile®, iOS®, Windows Phone®, Android®, HarmonyOS®, Tizen®, KaiOS®, Sailfish® OS, Ubuntu® Touch, CalyxOS®). Portable handheld devices may include cellular phones, smartphones, (e.g., an iPhone®), tablets (e.g., iPad®), and the like. Virtual personal assistants such as Amazon® Alexa®, Google® Assistant, Microsoft® Cortana®, Apple® Siri®, and others may be implemented on devices with a microphone and/or camera to receive user or environmental inputs, as well as a speaker and/or display to respond to the inputs. Wearable devices may include Apple® Watch, Samsung Galaxy® Watch, Meta Quest®, Ray-Ban® Meta® smart glasses, Snap® Spectacles, and other devices. Gaming systems may include various handheld gaming devices, Internet-enabled gaming devices (e.g., a Microsoft Xbox® gaming console with or without a Kinect® gesture input device, Sony PlayStation® system, Nintendo Switch®, and other devices), and the like. The client devices may be capable of executing various different applications such as various Internet-related apps, communication applications (e.g., e-mail applications, short message service (SMS) applications) and may use various communication protocols.

Network(s) 512 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 512 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 514 may be composed of one or more general purpose computers, specialized server computers (including, by way of example, PC (personal computer) servers, UNIX® servers, LINUX® servers, mid-range servers, mainframe computers, rack-mounted servers, etc.), server farms, server clusters, a Real Application Cluster (RAC), database servers, or any other appropriate arrangement and/or combination. Server 514 can include one or more virtual machines running virtual operating systems, or other computing architectures involving virtualization such as one or more flexible pools of logical storage devices that can be virtualized to maintain virtual storage devices for the server. In various aspects, server 514 may be adapted to run one or more services or software applications that provide the functionality described in the foregoing disclosure.

The computing systems in server 514 may run one or more operating systems including any of those discussed above, as well as any commercially available server operating system. Server 514 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAP®, Amazon®, Sybase®, IBM® (International Business Machines), and the like.

In some implementations, server 514 may include one or more applications to analyze and consolidate data feeds and/or event updates received from users of client computing devices 502, 504, 506, 508, and/or 510. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 514 may also include one or more applications to display the data feeds and/or real-time events via one or more display devices of client computing devices 502, 504, 506, 508, and/or 510.

Distributed system 500 may also include one or more data repositories 516, 518. These data repositories may be used to store data and other information in certain aspects. For example, one or more of the data repositories 516, 518 may be used to store information for techniques for managing resource allocation. Data repositories 516, 518 may reside in a variety of locations. For example, a data repository used by server 514 may be local to server 514 or may be remote from server 514 and in communication with server 514 via a network-based or dedicated connection. Data repositories 516, 518 may be of different types. In certain aspects, a data repository used by server 514 may be a database, for example, a relational database, a container database, an Exadata® storage device, or other data storage and retrieval tool such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 516, 518 may also be used by applications to store application data. The data repositories used by applications may be of different types such as, for example, a key-value store repository, an object store repository, or a general storage repository supported by a file system.

In one embodiment, server 514 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

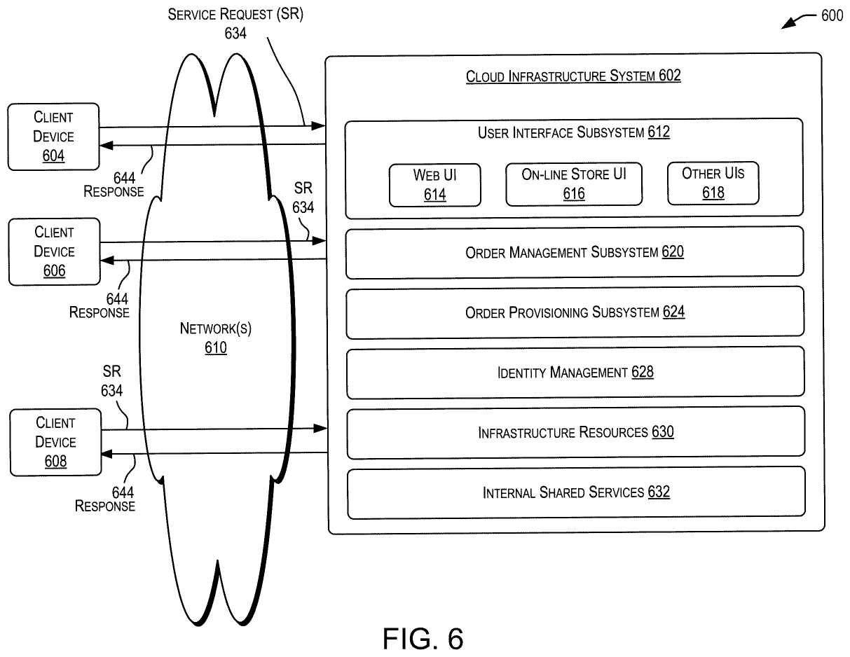

FIG. 6 is a simplified block diagram of a cloud-based system environment in which managing resource allocation, in accordance with certain aspects, may be performed. In the embodiment depicted in FIG. 6, cloud infrastructure system 602 may provide one or more cloud services that may be requested by users using one or more client computing devices 604, 606, and 608. Cloud infrastructure system 602 may comprise one or more computers and/or servers that may include those described above for server 514. The computers in cloud infrastructure system 602 may be organized as general purpose computers, specialized server computers, server farms, server clusters, or any other appropriate arrangement and/or combination.

Network(s) 610 may facilitate communication and exchange of data between clients 604, 606, and 608 and cloud infrastructure system 602. Network(s) 610 may include one or more networks. The networks may be of the same or different types. Network(s) 610 may support one or more communication protocols, including wired and/or wireless protocols, for facilitating the communications.

The embodiment depicted in FIG. 6 is only one example of a cloud infrastructure system and is not intended to be limiting. It should be appreciated that, in some other aspects, cloud infrastructure system 602 may have more or fewer components than those depicted in FIG. 6, may combine two or more components, or may have a different configuration or arrangement of components. For example, although FIG. 6 depicts three client computing devices, any number of client computing devices may be supported in alternative aspects.

The term cloud service is generally used to refer to a service that is made available to users on demand and via a communication network such as the Internet by systems (e.g., cloud infrastructure system 602) of a service provider. Typically, in a public cloud environment, servers and systems that make up the cloud service provider's system are different from the cloud customer's (“tenant's”) own on-premise servers and systems. The cloud service provider's systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via a network 610 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation®, such as database services, middleware services, application services, and others.

In certain aspects, cloud infrastructure system 602 may provide one or more cloud services using different models such as under a Software as a Service (SaaS) model, a Platform as a Service (PaaS) model, an Infrastructure as a Service (IaaS) model, a Data as a Service (DaaS) model, and others, including hybrid service models. Cloud infrastructure system 602 may include a suite of databases, middleware, applications, and/or other resources that enable provision of the various cloud services.

A SaaS model enables an application or software to be delivered to a tenant's client device over a communication network like the Internet, as a service, without the tenant having to buy the hardware or software for the underlying application. For example, a SaaS model may be used to provide tenants access to on-demand applications that are hosted by cloud infrastructure system 602. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a tenant as a cloud service to provide elastic compute and storage capabilities. Various IaaS services are provided by Oracle Corporation®.

A PaaS model is generally used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is generally used to provide data as a service. Datasets may searched, combined, summarized, and downloaded or placed into use between applications. For example, user profile data may be updated by one application and provided to another application. As another example, summaries of user profile information generated based on a dataset may be used to enrich another dataset.

Cloud services are generally provided on an on-demand self-service basis, subscription-based, elastically scalable, reliable, highly available, and secure manner. For example, a tenant, via a subscription order, may order one or more services provided by cloud infrastructure system 602. Cloud infrastructure system 602 then performs processing to provide the services requested in the tenant's subscription order. Cloud infrastructure system 602 may be configured to provide one or even multiple cloud services.

Cloud infrastructure system 602 may provide the cloud services via different deployment models. In a public cloud model, cloud infrastructure system 602 may be owned by a third party cloud services provider and the cloud services are offered to any general public tenant, where the tenant can be an individual or an enterprise. In certain other aspects, under a private cloud model, cloud infrastructure system 602 may be operated within an organization (e.g., within an enterprise organization) and services provided to clients that are within the organization. For example, the clients may be various departments or employees or other individuals of departments of an enterprise such as the Human Resources department, the Payroll department, etc., or other individuals of the enterprise. In certain other aspects, under a community cloud model, the cloud infrastructure system 602 and the services provided may be shared by several organizations in a related community. Various other models such as hybrids of the above mentioned models may also be used.

Client computing devices 604, 606, and 608 may be of different types (such as devices 502, 504, 506, and 508 depicted in FIG. 5) and may be capable of operating one or more client applications. A user may use a client device to interact with cloud infrastructure system 602, such as to request a service provided by cloud infrastructure system 602.

In some aspects, the processing performed by cloud infrastructure system 602 for providing chatbot services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 602 for determining the intent of an utterance. The data used for this analysis may include structured data (e.g., data stored in a database or structured according to a structured model) and/or unstructured data (e.g., data blobs (binary large objects)).

As depicted in the embodiment in FIG. 6, cloud infrastructure system 602 may include infrastructure resources 630 that are utilized for facilitating the provision of various cloud services offered by cloud infrastructure system 602. Infrastructure resources 630 may include, for example, processing resources, storage or memory resources, networking resources, and the like.

In certain aspects, to facilitate efficient provisioning of these resources for supporting the various cloud services provided by cloud infrastructure system 602 for different tenants, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 602 may itself internally use services 632 that are shared by different components of cloud infrastructure system 602 and which facilitate the provisioning of services by cloud infrastructure system 602. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 602 may comprise multiple subsystems. These subsystems may be implemented in software, or hardware, or combinations thereof. As depicted in FIG. 6, the subsystems may include a user interface subsystem 612 that enables users of cloud infrastructure system 602 to interact with cloud infrastructure system 602. User interface subsystem 612 may include various different interfaces such as a web interface 614, an online store interface 616 where cloud services provided by cloud infrastructure system 602 are advertised and are purchasable by a consumer, and other interfaces 618. For example, a tenant may, using a client device, request (service request 634) one or more services provided by cloud infrastructure system 602 using one or more of interfaces 614, 616, and 618. For example, a tenant may access the online store, browse cloud services offered by cloud infrastructure system 602, and place a subscription order for one or more services offered by cloud infrastructure system 602 that the tenant wishes to subscribe to. The service request may include information identifying the tenant and one or more services that the tenant desires to subscribe to. For example, a tenant may place a subscription order for a chatbot related service offered by cloud infrastructure system 602. As part of the order, the client may provide information identifying the input (e.g. utterances).

In certain aspects, such as the embodiment depicted in FIG. 6, cloud infrastructure system 602 may comprise a service management subsystem (OMS) 620 that is configured to process the new order. As part of this processing, OMS 620 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 620 may then invoke the service provisioning subsystem (OPS) 624 that is configured to provision resources for the order including processing, memory, and networking resources. The provisioning may include allocating resources for the order and configuring the resources to facilitate the service requested by the tenant order. The manner in which resources are provisioned for an order and the type of the provisioned resources may depend upon the type of cloud service that has been ordered by the tenant. For example, according to one workflow, OPS 624 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting tenant for providing the requested service.

Cloud infrastructure system 602 may send a response or notification 644 to the requesting tenant to indicate when the requested service is now ready for use. In some instances, information (e.g., a link) may be sent to the tenant that enables the tenant to start using and availing the benefits of the requested services.

Cloud infrastructure system 602 may provide services to multiple tenants. For each tenant, cloud infrastructure system 602 is responsible for managing information related to one or more subscription orders received from the tenant, maintaining tenant data related to the orders, and providing the requested services to the tenant or clients of the tenant. Cloud infrastructure system 602 may also collect usage statistics regarding a tenant's use of subscribed services. For example, statistics may be collected for the amount of storage used, the amount of data transferred, the number of users, and the amount of system up time and system down time, and the like. This usage information may be used to bill the tenant. Billing may be done, for example, on a monthly cycle.

Cloud infrastructure system 602 may provide services to multiple tenants in parallel. Cloud infrastructure system 602 may store information for these tenants, including possibly proprietary information. In certain aspects, cloud infrastructure system 602 comprises an identity management subsystem (IMS) 628 that is configured to manage tenant's information and provide the separation of the managed information such that information related to one tenant is not accessible by another tenant. IMS 628 may be configured to provide various security-related services such as identity services, such as information access management, authentication and authorization services, services for managing tenant identities and roles and related capabilities, and the like.

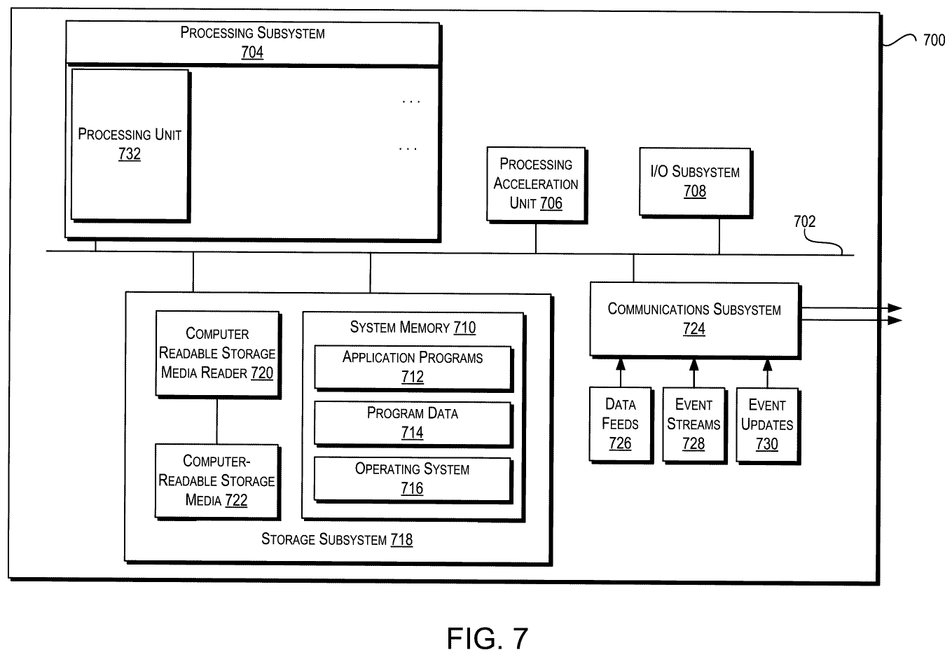

FIG. 7 illustrates an exemplary computer system 700 that may be used to implement certain aspects. As shown in FIG. 7, computer system 700 includes various subsystems including a processing subsystem 704 that communicates with a number of other subsystems via a bus subsystem 702. These other subsystems may include a processing acceleration unit 706, an I/O subsystem 708, a storage subsystem 718, and a communications subsystem 724. Storage subsystem 718 may include non-transitory and/or transitory computer-readable storage media including storage media 722 and a system memory 710.

Bus subsystem 702 provides a mechanism for letting the various components and subsystems of computer system 700 communicate with each other as intended. Although bus subsystem 702 is shown schematically as a single bus, alternative aspects of the bus subsystem may utilize multiple buses. Bus subsystem 702 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 704 controls the operation of computer system 700 and may comprise one or more processors, application specific integrated circuits (ASICs), or field programmable gate arrays (FPGAs). The processors may be single core or multicore processors. The processing resources of computer system 700 can be organized into one or more processing units 732, 734, etc. A processing unit may include one or more processors, one or more cores from the same or different processors, a combination of cores and processors, or other combinations of cores and processors. In some aspects, processing subsystem 704 can include one or more special purpose co-processors such as graphics processors, digital signal processors (DSPs), or the like. In some aspects, some or all of the processing units of processing subsystem 704 can be implemented using customized circuits, such as application specific integrated circuits (ASICs), or field programmable gate arrays (FPGAs).

In some aspects, the processing units in processing subsystem 704 can execute instructions stored in system memory 710 or on computer readable storage media 722. In various aspects, the processing units can execute a variety of programs or code instructions and can maintain multiple concurrently executing programs or processes. At any given time, some or all of the program code to be executed can be resident in system memory 710 and/or on computer-readable storage media 722 including potentially on one or more storage devices. Through suitable programming, processing subsystem 704 can provide various functionalities described above. In instances where computer system 700 is executing one or more virtual machines, one or more processing units may be allocated to each virtual machine.

In certain aspects, a processing acceleration unit 706 may optionally be provided for performing customized processing or for off-loading some of the processing performed by processing subsystem 704 so as to accelerate the overall processing performed by computer system 700.

I/O subsystem 708 may include devices and mechanisms for inputting information to computer system 700 and/or for outputting information from or via computer system 700. In general, use of the term input device is intended to include all possible types of devices and mechanisms for inputting information to computer system 700. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Quest® controller, Microsoft Kinect® motion sensor, the Microsoft Xbox® 360 game controller, or devices that provide an interface for receiving input using gestures and spoken commands. User interface input devices may also include eye gesture recognition devices such as a blink detector that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems (e.g., Siri® navigator or Amazon Alexa®) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 700 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest® or Microsoft HoloLens® may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 718 provides a repository or data store for storing information and data that is used by computer system 700. Storage subsystem 718 provides a tangible non-transitory computer-readable storage medium for storing the basic programming and data constructs that provide the functionality of some aspects. Storage subsystem 718 may store software (e.g., programs, code modules, instructions) that when executed by processing subsystem 704 provides the functionality described above. The software may be executed by one or more processing units of processing subsystem 704. Storage subsystem 718 may also provide a repository for storing data used in accordance with the teachings of this disclosure.

Storage subsystem 718 may include one or more non-transitory memory devices, including volatile and non-volatile memory devices. As shown in FIG. 7, storage subsystem 718 includes a system memory 710 and a computer-readable storage media 722. System memory 710 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 700, such as during start-up, may typically be stored in the ROM. The RAM typically contains data and/or program modules that are presently being operated and executed by processing subsystem 704. In some implementations, system memory 710 may include multiple different types of memory, such as static random access memory (SRAM), dynamic random access memory (DRAM), and the like.

By way of example, and not limitation, as depicted in FIG. 7, system memory 710 may load application programs 712 that are being executed, which may include various applications such as Web browsers, mid-tier applications, relational database management systems (RDBMS), etc., program data 714, and an operating system 716. By way of example, operating system 716 may include various versions of Microsoft Windows®, Apple Macintosh®, and/or Linux® operating systems, a variety of commercially-available UNIX® or UNIX-like operating systems (including without limitation the variety of GNU/Linux operating systems, the Oracle Linux®, Google Chrome® OS, and the like) and/or mobile operating systems such as iOS, Windows® Phone, Android® OS, and others.

Computer-readable storage media 722 may store programming and data constructs that provide the functionality of some aspects. Computer-readable media 722 may provide storage of computer-readable instructions, data structures, program modules, and other data for computer system 700. Software (programs, code modules, instructions) that, when executed by processing subsystem 704 provides the functionality described above, may be stored in storage subsystem 718. By way of example, computer-readable storage media 722 may include non-volatile memory such as a hard disk drive, a magnetic disk drive, an optical disk drive such as a CD ROM, digital video disc (DVD), a Blu-Ray® disk, or other optical media. Computer-readable storage media 722 may include, but is not limited to, Zip® drives, flash memory cards, universal serial bus (USB) flash drives, secure digital (SD) cards, DVD disks, digital video tape, and the like. Computer-readable storage media 722 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 718 may also include a computer-readable storage media reader 720 that can further be connected to computer-readable storage media 722. Reader 720 may receive and be configured to read data from a memory device such as a disk, a flash drive, etc.

In certain aspects, computer system 700 may support virtualization technologies, including but not limited to virtualization of processing and memory resources. For example, computer system 700 may provide support for executing one or more virtual machines. In certain aspects, computer system 700 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 700. Accordingly, multiple operating systems may potentially be run concurrently by computer system 700.

Communications subsystem 724 provides an interface to other computer systems and networks. Communications subsystem 724 serves as an interface for receiving data from and transmitting data to other systems from computer system 700. For example, communications subsystem 724 may enable computer system 700 to establish a communication channel to one or more client devices via the Internet for receiving and sending information from and to the client devices. For example, the communications subsystem may be used to transmit a response to a user regarding the inquiry for a chatbot.

Communications subsystem 724 may support both wired and/or wireless communication protocols. For example, in certain aspects, communications subsystem 724 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 724 can provide wired network connectivity (e.g., Ethernet) in addition to or instead of a wireless interface.

Communications subsystem 724 can receive and transmit data in various forms. For example, in some aspects, in addition to other forms, communications subsystem 724 may receive input communications in the form of structured and/or unstructured data feeds 726, event streams 728, event updates 730, and the like. For example, communications subsystem 724 may be configured to receive (or send) data feeds 726 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 724 may be configured to receive data in the form of continuous data streams, which may include event streams 728 of real-time events and/or event updates 730, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 724 may also be configured to communicate data from computer system 700 to other computer systems or networks. The data may be communicated in various different forms such as structured and/or unstructured data feeds 726, event streams 728, event updates 730, and the like to one or more databases that may be in communication with one or more streaming data source computers coupled to computer system 700.

Computer system 700 can be one of various types, including a handheld portable device (e.g., an iPhone® cellular phone, an iPad® computing tablet, a personal digital assistant (PDA)), a wearable device (e.g., a Meta Quest® head mounted display), a personal computer, a workstation, a mainframe, a kiosk, a server rack, or any other data processing system. Due to the ever-changing nature of computers and networks, the description of computer system 700 depicted in FIG. 7 is intended only as a specific example. Many other configurations having more or fewer components than the system depicted in FIG. 7 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A computer-implemented method comprising:
storing, in association with a particular time, a first trend marker that indicates a first aggregate resource usage trend for aggregate resource usage by one or more resource consumers; wherein the first aggregate resource usage trend is increasing or decreasing at the particular time;
periodically determining a first aggregate resource usage by the one or more resource consumers over a first window of time relative to an end of a corresponding period and a second aggregate resource usage by the one or more resource consumers over a second window of time relative to the end of the corresponding period, wherein the first window of time is shorter than the second window of time;
for a given period, comparing the first aggregate resource usage to the second aggregate resource usage to determine whether a second aggregate resource usage trend of the given period is consistent with the first aggregate resource usage trend;
based at least in part on determining that the second aggregate resource usage trend of the given period is not consistent with the first aggregate resource usage trend:
storing, in association with an end of the given period, a second trend marker that indicates the second aggregate resource usage trend for aggregate resource usage by the one or more resource consumers;
changing an allocation of computing resources available to the one or more resource consumers based on the second aggregate resource usage trend;
wherein the one or more resource consumers use computing resources according to the changed allocation.

2. The computer-implemented method of claim 1, further comprising, after an adjustment period has passed since the changing the allocation of computing resources, based at least in part on determining that the second trend marker is still a most recent trend marker, changing the allocation of computing resources available to the one or more resource consumers based on the second aggregate resource usage trend.

3. The computer-implemented method of claim 2, further comprising:
receiving, via an interface, a change to an allocation change size and an adjustment period length (could be an API or user interface);
wherein the changing the allocation of computing resources available to the one or more resource consumers changes the allocation by the allocation change size (step); and
wherein the periodically changing the allocation of computing resources occurs at intervals based on the adjustment period length (time factor).

4. The computer-implemented method of claim 1, further comprising, after an adjustment period has passed since the changing the allocation of computing resources, based at least in part on determining that the second trend marker is not still a most recent trend marker, maintaining an allocation of computing resources available to the one or more resource consumers without change.

5. The computer-implemented method of claim 1, wherein the changing the allocation of computing resources available to the one or more resource consumers based on the second aggregate resource usage trend results in a first allocation of computing resources;
wherein the method further comprises:
for another given period, comparing the first aggregate resource usage to the second aggregate resource usage to determine whether a third aggregate resource usage trend of the other given period is consistent with the second aggregate resource usage trend; and
based at least in part on determining that the third aggregate resource usage trend of the other given period is not consistent with the second aggregate resource usage trend:
storing, in association with an end of the other given period, a third trend marker that indicates the third aggregate resource usage trend for aggregate resource usage by the one or more resource consumers; and
changing an allocation of computing resources available to the one or more resource consumers based on the third aggregate resource usage trend to result in a second allocation of computing resources;
wherein the one or more resource consumers use computing resources according to the first allocation before changing the allocation of computing resources available to the one or more resource consumers based on the third aggregate resource usage trend; and
wherein the one or more resource consumers use computing resources according to the second allocation after changing the allocation of computing resources available to the one or more resource consumers based on the third aggregate resource usage trend.

6. The computer-implemented method of claim 1, wherein the changing the allocation of computing resources available to the one or more resource consumers is performed by a resource management node of a plurality of resource management nodes; wherein other resource management nodes of the plurality of resource management nodes manage allocation of resources for one or more other resource consumers of a plurality of resource consumers.

7. The computer-implemented method of claim 1, further comprising monitoring unused allocated resources, and separately allocating an amount of resources based at least in part on determining that a lower threshold of unused allocated resources is satisfied.

8. The computer-implemented method of claim 1, further comprising monitoring unused allocated resources, and separately de-allocating an amount of resources based at least in part on determining that an upper threshold of unused allocated resources is satisfied.

9. The computer-implemented method of claim 1, wherein the determining that the second aggregate resource usage trend of the given period is not consistent with the first aggregate resource usage trend comprises determining that the second aggregate resource usage trend is positive or negative while the first aggregate resource usage trend is negative or positive, respectively.

10. The computer-implemented method of claim 1, wherein the determining that the second aggregate resource usage trend of the given period is not consistent with the first aggregate resource usage trend comprises determining that the second aggregate resource usage trend exhibits a second rate of change that is in a different range than the first rate of change even though the first aggregate resource usage trend and the second aggregate resource usage trend are in the same direction. (absolute range fixed ahead-of-time (e.g., slope of 2, 3, 4, 5) or relative range where one of those thresholds is based on the current value (e.g., change of 20% from current value of 2)).

11. The computer-implemented method of claim 1, further comprising, for a period of decreased resource usage, increasing a step amount based on determining that an upper threshold of unused allocated resources is satisfied (give more back because we have more to give back).

12. The computer-implemented method of claim 1, further comprising, for a period of increased resource usage, increasing a step amount based on determining that a lower threshold of unused allocated resources is satisfied. (take more because we have little to spare).

13. A computer-program product comprising one or more non-transitory machine-readable storage media, including stored instructions configured to cause a computing system to perform a set of actions including:
storing, in association with a particular time, a first trend marker that indicates a first aggregate resource usage trend for aggregate resource usage by one or more resource consumers; wherein the first aggregate resource usage trend is increasing or decreasing at the particular time;
periodically determining a first aggregate resource usage by the one or more resource consumers over a first window of time relative to an end of a corresponding period and a second aggregate resource usage by the one or more resource consumers over a second window of time relative to the end of the corresponding period, wherein the first window of time is shorter than the second window of time;
for a given period, comparing the first aggregate resource usage to the second aggregate resource usage to determine whether a second aggregate resource usage trend of the given period is consistent with the first aggregate resource usage trend;
based at least in part on determining that the second aggregate resource usage trend of the given period is not consistent with the first aggregate resource usage trend:
storing, in association with an end of the given period, a second trend marker that indicates the second aggregate resource usage trend for aggregate resource usage by the one or more resource consumers;
changing an allocation of computing resources available to the one or more resource consumers based on the second aggregate resource usage trend;
wherein the one or more resource consumers use computing resources according to the changed allocation.

14. The computer-program product of claim 13, wherein the changing the allocation of computing resources available to the one or more resource consumers based on the second aggregate resource usage trend results in a first allocation of computing resources;
wherein the set of actions further includes:
for another given period, comparing the first aggregate resource usage to the second aggregate resource usage to determine whether a third aggregate resource usage trend of the other given period is consistent with the second aggregate resource usage trend; and
based at least in part on determining that the third aggregate resource usage trend of the other given period is not consistent with the second aggregate resource usage trend:
storing, in association with an end of the other given period, a third trend marker that indicates the third aggregate resource usage trend for aggregate resource usage by the one or more resource consumers; and
changing an allocation of computing resources available to the one or more resource consumers based on the third aggregate resource usage trend to result in a second allocation of computing resources;
wherein the one or more resource consumers use computing resources according to the first allocation before changing the allocation of computing resources available to the one or more resource consumers based on the third aggregate resource usage trend; and
wherein the one or more resource consumers use computing resources according to the second allocation after changing the allocation of computing resources available to the one or more resource consumers based on the third aggregate resource usage trend.

15. The computer-program product of claim 13, wherein the changing the allocation of computing resources available to the one or more resource consumers is performed by a resource management node of a plurality of resource management nodes; wherein other resource management nodes of the plurality of resource management nodes manage allocation of resources for one or more other resource consumers of a plurality of resource consumers.

16. The computer-program product of claim 13, wherein the determining that the second aggregate resource usage trend of the given period is not consistent with the first aggregate resource usage trend comprises determining that the second aggregate resource usage trend is positive or negative while the first aggregate resource usage trend is negative or positive, respectively.

17. The computer-program product of claim 13, wherein the determining that the second aggregate resource usage trend of the given period is not consistent with the first aggregate resource usage trend comprises determining that the second aggregate resource usage trend exhibits a second rate of change that is in a different range than the first rate of change even though the first aggregate resource usage trend and the second aggregate resource usage trend are in the same direction.

18. A system comprising:
one or more processors;
one or more non-transitory computer-readable media storing instructions, which, when executed by the system, cause the system to perform a set of actions including:
storing, in association with a particular time, a first trend marker that indicates a first aggregate resource usage trend for aggregate resource usage by one or more resource consumers; wherein the first aggregate resource usage trend is increasing or decreasing at the particular time;
periodically determining a first aggregate resource usage by the one or more resource consumers over a first window of time relative to an end of a corresponding period and a second aggregate resource usage by the one or more resource consumers over a second window of time relative to the end of the corresponding period, wherein the first window of time is shorter than the second window of time;
for a given period, comparing the first aggregate resource usage to the second aggregate resource usage to determine whether a second aggregate resource usage trend of the given period is consistent with the first aggregate resource usage trend;
based at least in part on determining that the second aggregate resource usage trend of the given period is not consistent with the first aggregate resource usage trend:
storing, in association with an end of the given period, a second trend marker that indicates the second aggregate resource usage trend for aggregate resource usage by the one or more resource consumers;
changing an allocation of computing resources available to the one or more resource consumers based on the second aggregate resource usage trend;
wherein the one or more resource consumers use computing resources according to the changed allocation.

19. The system of claim 18, wherein the changing the allocation of computing resources available to the one or more resource consumers based on the second aggregate resource usage trend results in a first allocation of computing resources;
wherein the set of actions further includes:
for another given period, comparing the first aggregate resource usage to the second aggregate resource usage to determine whether a third aggregate resource usage trend of the other given period is consistent with the second aggregate resource usage trend; and
based at least in part on determining that the third aggregate resource usage trend of the other given period is not consistent with the second aggregate resource usage trend:
storing, in association with an end of the other given period, a third trend marker that indicates the third aggregate resource usage trend for aggregate resource usage by the one or more resource consumers; and
changing an allocation of computing resources available to the one or more resource consumers based on the third aggregate resource usage trend to result in a second allocation of computing resources;
wherein the one or more resource consumers use computing resources according to the first allocation before changing the allocation of computing resources available to the one or more resource consumers based on the third aggregate resource usage trend; and
wherein the one or more resource consumers use computing resources according to the second allocation after changing the allocation of computing resources available to the one or more resource consumers based on the third aggregate resource usage trend.

20. The system of claim 18, wherein the changing the allocation of computing resources available to the one or more resource consumers is performed by a resource management node of a plurality of resource management nodes; wherein other resource management nodes of the plurality of resource management nodes manage allocation of resources for one or more other resource consumers of a plurality of resource consumers.

21. The system of claim 18, wherein the determining that the second aggregate resource usage trend of the given period is not consistent with the first aggregate resource usage trend comprises determining that the second aggregate resource usage trend is positive or negative while the first aggregate resource usage trend is negative or positive, respectively.

22. The system of claim 18, wherein the determining that the second aggregate resource usage trend of the given period is not consistent with the first aggregate resource usage trend comprises determining that the second aggregate resource usage trend exhibits a second rate of change that is in a different range than the first rate of change even though the first aggregate resource usage trend and the second aggregate resource usage trend are in the same direction.
